(19) United States
(12) Patent Application Publication
(10) Pub. No.: US 2005/0086080 A1
(43) Pub. Date: Apr. 21, 2005

(54) Healthcare consumer information tool

(75) Inventors: MaryAnn Stump, Apple Valley, MN (US); Stephen Griffiths, Edina, MN (US); Patricia Ball, St. Paul, MN (US); Neil Chaffee, St. Paul, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Blue Cross Blue Shield of Minnesota, Eagan, MN (US)

(21) Appl. No.: 10/900,852

(22) Filed: Jul. 28, 2004

Related U.S. Application Data
(60) Provisional application No. 60/491,488, filed on Jul. 31, 2003.

(51) Int. Cl. G06F 17/60

(52) U.S. Cl. 705/2

(57) ABSTRACT

A health care consumer information tool may include a header listing, a body listing and a footer listing. The header listing may provide physical information about a health care entity. The body listing may provide a series of category headings, each having a series of metrics. For each metric a factual or descriptive assessment of the health care entity may be displayed. The footer listing may provide information designated by the health care entity itself. The header, body and footer listing may be arranged to be like a nutrition label, as provided in 21 C.F.R. (Apr. 1, 2003 edition) section 101.9(d)(12). The tool may be available to consumers in print, online, or in another accessible format.

### CROSS-REFERENCE TO RELATED APPLICATIONS

This application claims the benefit of U.S. Provisional Application No. 60/60/491,488, filed on Jul. 31, 2003, entitled “CONSUMER HEALTH CARE INFORMATION METHOD AND TOOL,” the contents of which are incorporated herein by reference.

### BACKGROUND OF THE INVENTION

Beginning in the late 1980s, an increasing amount of attention has been paid to performance measurement of various aspects of the American health care system, in the form of “report cards,” “provider profiles,” or “performance reports.” A major rationale for the production and dissemination of quality information has been to provide consumers with information that invite them to make better health care decisions, especially when they are faced with economic incentives to find the most value for their—not the insurance company's—dollar. More engaged, discriminating consumers motivate providers to compete for their business, to find ways to clearly define their value, and to improve their quality of care. (J. H. Hibbard, “Engaging Health Care Consumers to Improve the Quality of Care,” Medical Care 41, supplement 1 (2003): 161-170.)

One of the earliest efforts at publishing hospital outcomes data was spearheaded by the federal government. In 1986, the Health Care Financing Administration (“HCFA”) began releasing hospital mortality rates to the general public; by 1992, however, the reports were discontinued because consumers were not using the information. (S. T. Mennemeyer, M. A. Morrisey, and L. Z. Howard, “Death and Reputation: How Consumers Acted Upon HCFA Mortality Information,” Inquiry 34, no. 2 (Summer 1997): 117-28.) Individual states also embarked on reporting efforts. In 1992, the state of Pennsylvania began publishing risk-adjusted mortality rates for every hospital, surgeon, and surgical group performing coronary artery bypass graft (“CABG”) surgery. A 1996 study surveyed patients who had undergone CABG surgery and found that only 12% of patients knew about the report prior to surgery, and less than 1% reported that it had made an impact on their selection of provider. (E. C. Schneider and A. M. Epstein, “Use of Public Performance Reports: A Survey of Patients Undergoing Cardiac Surgery,” Journal of the Americal Medical Association 279 no. 2 (May 27, 1998): 1638-1642.) Consumers also did not appear to respond to information produced by the state of New York on hospital risk-adjusted death rates following CABG surgery: market share for the highest-mortality hospitals did not decrease following the release of the information, nor did market share increase for lowest-mortality hospitals. (M. R. Chassin, “Achieving and Sustaining Improved Quality: Lessons from New York State and Cardiac Surgery,” Health Affairs (July/August 2002): 40-51.) These examples of hospital performance reporting included relatively technical data that consumers may not have understood fully.

Yet another approach to hospital performance reporting has attempted to rate hospitals overall or by condition or procedure. Websites such as healthgrades.com, usnews.com, and calhospitals.org present summarized ratings of hospitals, using data from various sources, including Medicare billing data and patient surveys. (A. H. Rosenstein, “Hospital Report Cards: Friend or Foe,” Journal of Clinical Outcomes Management 11, no. 2 (February 2004).) These tools also suffer from serious deficiencies, however. Many rely on data for Medicare patients only, which limits their applicability to non-Medicare patients in some cases, especially in services that aren't relevant to the Medicare population; obstetrics and pediatrics are two examples. In addition, although the organizations producing this newer generation of hospital performance tools have made significant attempts to make them more “consumer-friendly,” most of the tools continue to be based on extremely complex methodologies that are difficult for consumers to really understand. Finally they are usually heavily reliant on Internet technology to get to consumers. This means that consumers who do not have access to the Internet, or who are less comfortable using the Internet, have a difficult time getting access to the information that they need.

Although studies have shown that consumers have not found hospital reports very useful so far, recent surveys have found that consumers do in fact have an appetite for more information on health care providers. In a 2000 consumer survey done by the Kaiser Family Foundation, 85% of respondents who had seen quality information comparing hospitals thought it would be useful in making decisions. (The Kaiser Family Foundation/Agency for Health Care Research and Quality, National Survey on Americans as Health Care Consumers: An Update on the Role of Quality Information (Menlo Park, Calif.: Kaiser Family Foundation, 2000).) In another 2000 consumer survey, the majority of respondents had little trust in health care providers and are interested in seeking new sources of information on quality and performance, instead of relying on friends and family for recommendations. (Deloitte and Touche, Consumer Demand for Clinical Quality: The Giant Awakens (Irving, Tex.: VHA, 14 Dec. 2001).) Furthermore, if health care payers and purchasers work together with health care providers, one is more likely to find new methods for capturing and reporting information that consumers find useful in making health care decisions. (T. H. Lee, et al, “A Middle Ground on Public Accountability,” The New England Journal of Medicine, 350 no. 23 (Jun. 3, 2004): 2409-2412.) These findings suggest that there is room for innovation in provider performance reporting and, that if developed collaboratively, presented well and accompanied by educational efforts, new tools are likely to be favorably received by consumers.

### SUMMARY OF THE INVENTION

The health care consumer information tool may include a header listing, a body listing and a footer listing. The header listing may provide physical information about a health care entity. The body listing may provide a series of category headings, each having a series of metrics. For each metric a factual or descriptive assessment of the health care entity may be displayed. The footer listing may provide information designated by the health care entity itself. The header, body and footer listing may be arranged to be like a nutrition label, as provided in 21 C.F.R. (Apr. 1, 2003 edition) section 101.9(d)(12).

It is an object of the invention to be recognizable and inviting, and not intimidating. It is an object of the invention to be platform-independent, able to be delivered through a variety of channels. Yet another object of the invention is for the information to be based on what consumers want to know, not simply what is easiest measure. Another object of the invention is that the information should be presented in a “best-fit, best-value” format (based on the individual consumers needs and preferences) and not as a prescriptive report card.

Recognizable Format

The health care consumer information tool may be patterned after a simple, yet ubiquitous template for providing information: the Nutrition Facts label found on every food and beverage product sold in the United States. See FIG. 1. Consumers have been using Nutrition Facts labels since 1994 and are familiar with its layout. (http://www.cfsan.fda.gov/`lrd/tpaward.html) Its concise, abbreviated format is attractive because we do not want to inundate consumers with information about each provider—therefore, the information is designed to be no more than one page in length (with additional pages for education on the tool, including definitions). The tool is also designed to capitalize on the ease of comparison that the Nutrition Facts label affords. As consumers have grown accustomed to using Nutrition Facts information to compare similar products, they should be able to learn to make comparisons among hospitals and other providers.

Platform-Independent

The health care consumer information tool is designed to be platform independent; that is, able to be distributed through the web or in paper form. The web is a natural home for the health care consumer information tool, given its ability to present a vast amount of information in a relatively uncluttered format, drill-downs to further information, links to other sites, and ease of updating and distributing the information. However, the health care consumer information tool is deployable in paper form as well, to meet the needs of consumers who don't have access to the web or are uncomfortable with that environment. Paper copies might also be made available by the participating hospitals, or included in an employee's health plan offerings or a new enrollee's benefit package.

Based on Consumer Feedback

To increase the chances that the health care consumer information tool would be a useful tool, the tool is based on information obtained directly from consumer design groups in which we show consumers mock-ups of the tool and ask for feedback overall and on specific items. We assess their level of comprehension on items that we have included in the mock-ups and then edit or remove confusing items or items that they deem uninteresting. We also ask for new, additional items.

“Best-Fit, Best-Value” Philosophy

The newest wave of hospital reporting typically produces ratings for hospitals, based on a letter grade or one to three or four stars or something similar, which suggests that there is a “best” hospital for any given patient, either overall or for certain conditions or procedures. Ratings can be confusing, especially if they are contradictory due to differences in methodologies used. Perhaps more importantly, though, ratings fail to give the impression that there might be aspects of a provider's practice that might appeal to people differentially and influence their decisions to seek care. “Best-fit, best-value” is more in line with a philosophy of patient-centered care that is respectful of the values and preferences of individual patients.

### BRIEF DESCRIPTION OF THE DRAWINGS

FIG. 1 is a representative Nutrition Facts label of which the reporting tool of the present invention resembles.

FIG. 2 is a representative sample of the health care consumer information tool for a single hospital, illustrating the standard one-page format.

FIG. 3 is a sample of the health care consumer information tool data definitions, illustrating the standard “side-by-side” format for the consumer definition and provider definition.

FIG. 4 is a flowchart illustrating the primary steps in the process of developing the health care consumer information tool.

### DETAILED DESCRIPTION OF THE INVENTION

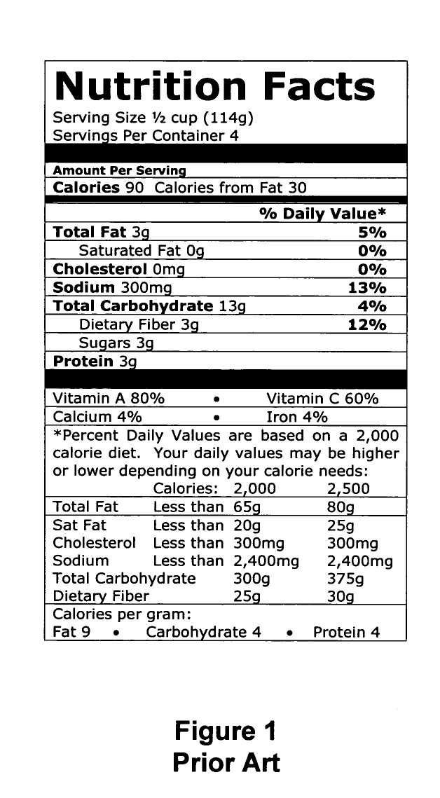

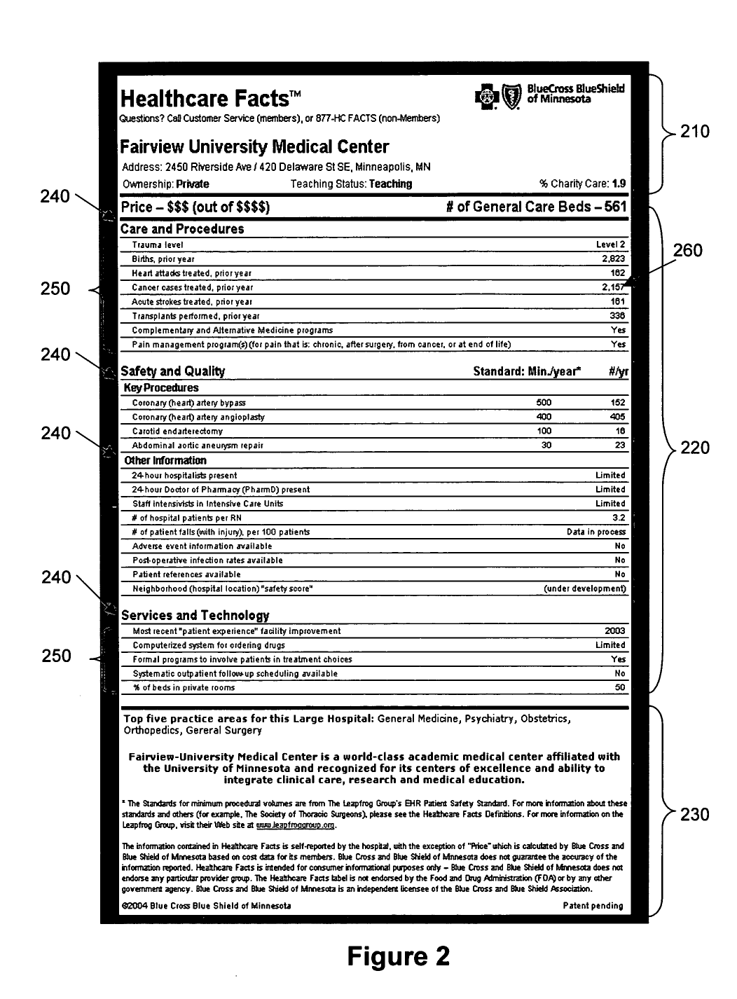

FIG. 2 shows one embodiment of the health care consumer information tool, such as may be offered by BlueCross BlueShield of Minnesota under the trademark Healthcare Facts®. The information of the information tool may be provided to consumers in a web-based format, a printed page, or other accessible format. When shown in paper form, the information may be limited to a single page (8.5 by 11-inch paper). The information may consist of a “header” 210 showing such information as the health care provider entity's name, address and additional descriptive information; a “main body” section 220 that shows information on the health care provider entity's price, volume of services provided for select types of care, information on safety and quality programs and resources at the health care provider entity, and information on select services and technologies offered to consumers by the health care entity; a “footer” section 230 containing information that the health care provider entity chooses to give to consumers around its key practice areas as well as a space for the health care provider entity to directly address consumers with a brief statement. The body section 220 may contain a set of category headings 240, each having one or more metrics 250. The metrics 250 may have factual or descriptive assessments 260 assigned to them. Some metrics 250 may be associated to standards (that are shown or are available to consumers) to compare against the health care entity's actual results or performance. Comparing FIG. 2 to FIG. 1, one can see that the information shown on the tool may be formatted in a way that resembles the Nutrition Facts label, in order to invoke a sense of familiarity with consumers.

Other embodiments of the invention may format the tool differently than shown in FIG. 2, while maintaining the spirit of the invention. For example, another embodiment may include a “header” section showing such information as the health care provider entity's name, address and additional descriptive information. This may then be followed by “modular” information for each of several different services potentially offered by a health care provider entity. One example of this embodiment may by a tool showing information for a health care provider entity of the type “physician clinic.” Such an embodiment may contain a header with the clinic's name, address of its location(s), hours of operation, languages spoken, and other types of information that apply to the health care provider entity as a whole. This header may then be followed by a module contain category headings and/or metrics for a specific physician practice specialty area (examples may include “Family Practice” or “Pediatrics”). Additional modules for other physician practice specialty areas may be shown subsequently. Similar to the embodiment described above, this embodiment and additional embodiments may present information in a way that resembles the Nutrition Facts label, in order to invoke a sense of familiarity with consumers.

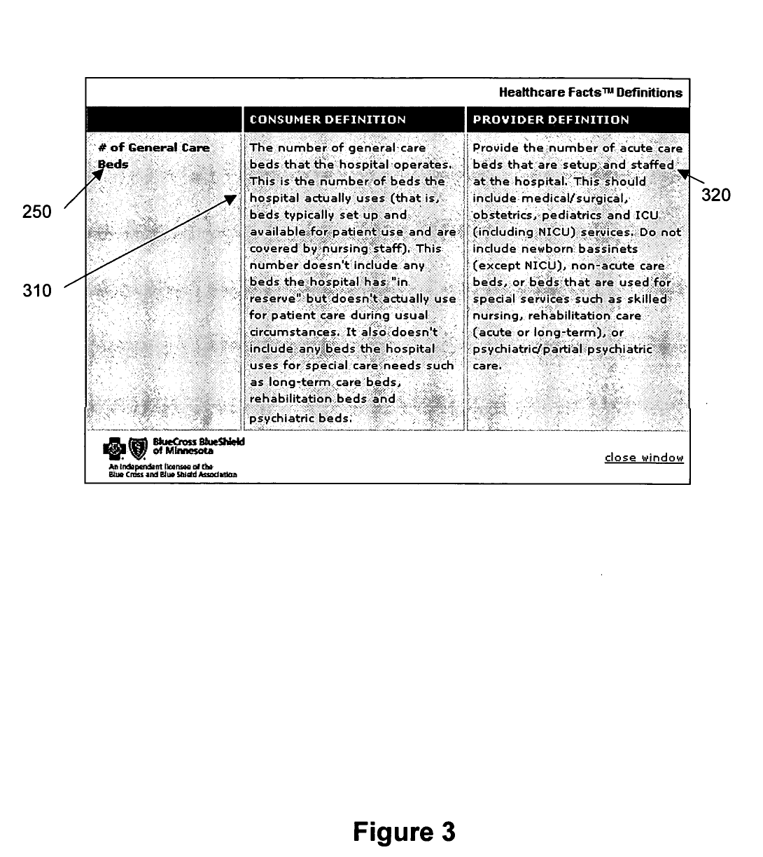

A side-by-side set of consumer and provider data definitions may be available for each item on the tool (see FIG. 3). FIG. 3 shows one embodiment of the data definitions that may accompany and support the health care consumer information tool. These data definitions may list the metrics 250 along with a consumer definition 310 that is developed from a consumer's point of view and provides information about what each item is and how and why that information might be important to the consumer. They definitions may also include a health care provider definition 320 (typically described simply as a “provider definition”) that is developed from a health care provider entity's point of view. This part of the definition may provide specific, narrow criteria instructing health care provider entities how to measure, or otherwise provide a response, to each item appearing on the health care consumer information tool. These two data definitions 310 and 320 may be presented in a side-by-side fashion in order to provider maximum transparency to all parties involved and to help consumers and health care providers have the best possible understanding of what each item represents.

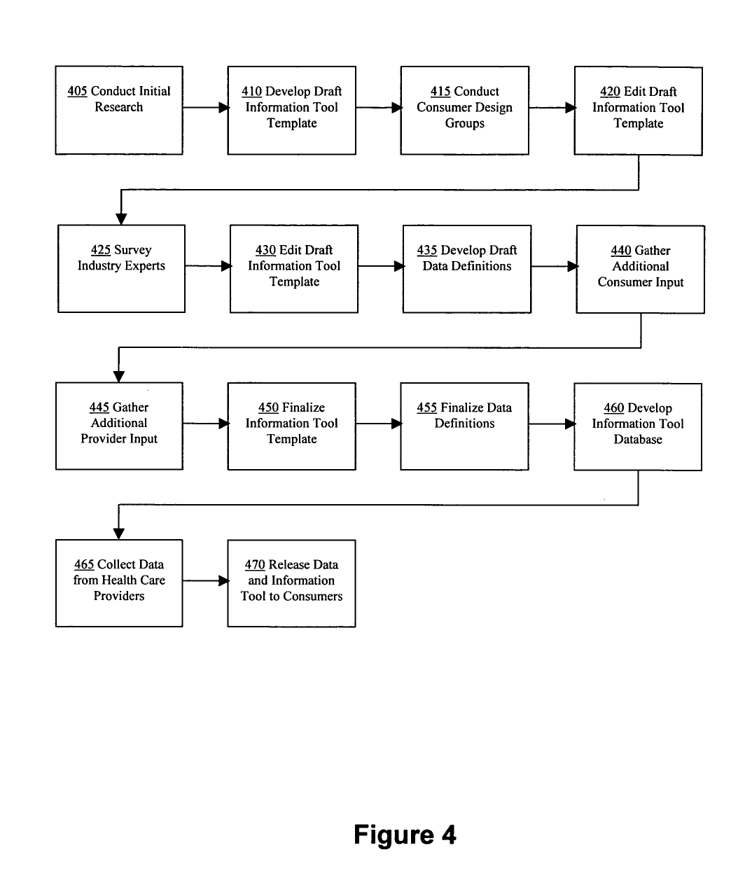

FIG. 4 shows the basic process steps in one embodiment of the invention as it produces a health care consumer information tool for a particular type of health care provider entity. The first primary step may be to conduct initial research 405. This may involve examining the relevant academic and trade literature and popular press for basic insights into consumer needs and preferences and information available about health care providers. In addition, step 405 may include discussions with consumers, consumer groups, or health care providers about potential content. Then a draft version of the tool template may be developed 410. This step may involve consolidating initial ideas for content, organization and presentation style obtained from step 405.

Consumer design groups may then be conducted 415. Conducting such groups may involve convening groups of relevant health care consumers or using existing consumer groups within the community. These consumer groups may be presented with the draft version of the tool template developed in step 410. Feedback on the draft may then be generated using a variety of techniques that may include direct questioning, simulated decision-making situations, and other exercises. Based on the feedback from step 415, the template may then be edited 420. Editing may involve adding, removing or changing the order of category headings 240 or metrics 250. Then, industry experts may be surveyed 425 in order to determine technical feasibility of collecting information on metrics 250, and for metrics 250 that are feasible, to determine the key components of the consumer definition 310 and provider definition 320. Based on the acquired information, the template may be edited again 430. This may involve removing or changing category headings 240 or metrics 250.

Once the template is generally finished, then draft data definitions may be developed 435, both for the consumer and the provider. Drafting the definitions may involve researching “best practices” or generally accepted ways within the health care industry of defining and measuring concepts that are similar to the metrics 250. Industry experts with particular expertise relative a particular metric 250 may be asked to provide a suggested definition for that metric.

Additional consumer input may then be gathered 440 in order to ensure that the revised template and draft data definitions remain in-line with the preferences and interests expressed by consumers in step 415 and that the draft tool as a whole is understandable and useful. Similarly, additional provider input may be gathered 445 in order to ensure that the metrics 250 are measurable and that the data definitions 310 and 320 provide a coherent and accurate description of the metrics 250.

Based on this additional information, the template may be finalized 450. Finalizing the template may involve one last round of changing category headings 240 or metrics 250. The data definitions may also be finalized 455. To do this, one may make one last change to data definitions 310 or 320 based on the finalized template 450.

Once the template and definitions are in their final form, a database may be developed to house this information 460. Developing the database may involve the steps of choosing a database technology to contain the data, modeling the structure of the data within the database technology, and developing a process and technology for collecting the data from participating health providers.

Data may be collected from a group of health care providers based on the definitions 465. Collecting this information may involve identifying participating providers and deploying the data collection process and technology developed in step 460. Then the information tool for a health care provider may be constructed based on the template and the collected information. In one embodiment, the information tool is designed to look like a Nutrition Facts label. The tool may then be released to consumers 470.

The foregoing description addresses embodiments encompassing the principles of the present invention. The embodiments may be changed, modified and/or implemented using various types of arrangements. Those skilled in the art will readily recognize various modifications and changes that may be made to the invention without strictly following the exemplary embodiments and applications illustrated and described herein, and without departing from the scope of the invention, which is set forth in the following claims. For example, the process flow shown in FIG. 4 may be modified as appropriate, such as by rearranging the steps, processing some steps concurrently, or using another similar system flow.

1. A reporting tool for health care consumers for presenting information about a health care entity, comprising:
a header listing for providing physical information of the health care entity;
a body listing for providing a plurality of category headings, a plurality of metrics for each of the plurality of category headings, and assessments of the health care entity for each of the plurality of metrics, wherein each of the assessments are factual or descriptive; and
a footer listing for providing information designated by the health care entity;
wherein the header listing, the body listing and the footer listing are arranged to be suggestive of a nutrition label arrangement, as provided in 21 C.F.R. (Apr. 1, 2003 edition) section 101.9(d)(12).

2. The reporting tool from claim 1, wherein the plurality of category headings comprise: a category for care and procedures, a category for safety and quality, and a category for services and technology.

3. The reporting tool from claim 1, wherein the assessments for each of the plurality of metrics are based on health-care-entity-wide data.

4. The reporting tool from claim 1, wherein at least one of the assessments is indirect, whereby the health care consumers are directed to an assessment source for assessment details.

5. The reporting tool from claim 4, wherein one of the assessments is directed to details on adverse event information.

6. The reporting tool from claim 4, wherein one of the assessments is directed to patient references.

7. The reporting tool from claim 1, wherein the plurality of metrics are subdivided into a first plurality of metrics related to price information and a second plurality of metrics related to non-price information.

8. The reporting tool from claim 1, wherein one of the plurality of metrics is directed to an availability of pain management programs.

9. The reporting tool from claim 1, wherein one of the plurality of metrics is directed to a facility improvement designed to improve the experience of the health care consumer.

10. The reporting tool from claim 1, wherein the health care entity is a hospital.

11. The reporting tool from claim 1, wherein the assessments are self-reported by the health care entity based on a definition that describes how to measure the metric.

12. The reporting tool from claim 1, wherein the plurality of category headings are suggestive of bold printed nutrient headings, as provided in 21 C.F.R. (Apr. 1, 2003 edition) section 101.9(d)(1)(iv).

13. A method for generating a reporting tool for health care consumers that presents information about a health care entity, the method comprising:
choosing a plurality of metrics of interest to the health care consumers;
creating a definition for each of the plurality of metrics that describes how to measure the metric;
receiving data from the health care entity for a plurality of assessments corresponding to the plurality of metrics; and
generating a report for the health care entity based on the plurality of metrics and the plurality of assessments, wherein the report is configured to be suggestive of a nutrition label arrangement, as provided in 21 C.F.R. (Apr. 1, 2003 edition) section 101.9(d)(12).

14. The method from claim 13, wherein the plurality of assessments are based on health-care-entity-wide data.

15. The method from claim 13, wherein at least one of the assessments is indirect, whereby the health care consumers are directed to an assessment source for assessment details.

16. The method from claim 15, wherein one of the assessments is directed to details on adverse event information.

17. The method tool from claim 15, wherein one of the assessments is directed to patient references.

18. The method from claim 13, wherein the plurality of metrics are subdivided into a first plurality of metrics related to price information and a second plurality of metrics related to non-price information.

19. The method from claim 13, wherein one of the plurality of metrics is directed to an availability of pain management programs.

20. The method from claim 13, wherein one of the plurality of metrics is directed to a location safety score.

21. The method from claim 13, wherein one of the plurality of metrics is directed to a facility improvement designed to improve an experience of the health care consumer.

22. The method from claim 13, wherein the health care entity is a hospital.

23. The method from claim 13, wherein the assessments are self-reported by the health care entity based on a definition that describes how to measure the metric.

24. A reporting tool for health care consumers for presenting information about a health care entity, comprising:
a listing for providing a plurality of category headings, a plurality of metrics for each of the plurality of category headings, and assessments of a health care entity for each of the plurality of metrics, wherein each of the assessments are factual or descriptive;
wherein the listing is arranged to be suggestive of a nutrition label arrangement, as provided in 21 C.F.R. (Apr. 1, 2003 edition) section 101.9(d)(12).
